(19) United States
(12) Patent Application Publication
(10) Pub. No.: US 2016/0193538 A1
(43) Pub. Date: Jul. 7, 2016

(54) Performance Stage Lift Systems

(71) Applicant: Jose Cantu, Gardena, CA (US)

(72) Inventor: Jose Cantu, Gardena, CA (US)

(21) Appl. No.: 14/589,358

(22) Filed: Jan. 5, 2015

(51) Int. Cl. A63J 1/02; B66F 11/04; B66F 11/00

(52) U.S. Cl. CPC A63J 1/02; B66F 11/00; B66F 11/04

(57) ABSTRACT

An elevator or lift system is arranged as a high performance stage component which integrates with modular stage systems to effect means by which a load may be easily conveyed from spaces beneigth a stage surface to the stage surface with special effect. A lift deck travels linearly within a space demarked by a system frameset under motivation from a special purpose drive systems and electric motor. The drive system is specially configured with a very slim profile to maximize usable space for payloads and without requiring consumption of spaces surrounding the device. An powerful electronic motor provides high acceleration in view of specific loads (i.e. performers) to be delivered to the stage surface and in further view of a desired launch profile.

### BACKGROUND OF THE INVENTION

1. Field

The following invention disclosure is generally concerned with equipment and apparatus in support of performing arts and specifically concerned with stage apparatus arranged to provide a high performance lift function.

2. Related Systems

Performance stages are often erected as temporary structures assembled with specific purpose and design in support of a stage show performance. The design and nature of the performance can have an impact on the design of the stage apparatus. Indeed, many components of a purpose built stage set may include elements which contribute to and provide for special effects of the show performance.

For example, many stages have been erected with a grand staircase integrated with a rear portion of a stage set to permit a performer to make a spectacular entry to the performance space. In combination with special lighting and pyrotechnics, such staircases may be used to permit performers to pass from a ‘backstage’ area onto the main performance surface of the stage. These types of special effect performer entries are frequently an important part of a stage show design. The show choreographer carefully works with the stage designer to produce stage components which serve the performance objectives and stunts which may be incorporated as part of the performance.

Stage designers have gone to great lengths to provide for spectacular entries for performers. In one act, a large retractable ferris wheel was integrated with a stage set and used by a performer known as ‘Eminem’ in his [name??] show. After Eminem entered the performance space and began to walk about the primary stage surface, the ferris wheel was retracted back to permit a more clear performance area. When performance stage component is used for performer entry, it is often the case that the component must remain in place and when it does, it must not interfere appreciably with the remaining portions of the show.

From too far back in the annals of stage performances would historians have to look to find the first ‘trap door’ type apparatus which permits performers to enter the main stage surfaces from a space below the stage. A door which operates as a portion of the stage surface in one mode, swings away from that position to create an open passageway to spaces beneigth the stage whereby actors may enter and exit the stage for example via a hidden staircase.

Of course, the prior art is full of interesting versions of the trap door used to make performer appear and disappear with precise sychronicity with respect to related events in other parts of the show. Indeed the trap door stage access could be considered a most popular mechanism by which show designers have used to permit performers to slyly enter and exit the stages on which they deliver their performances. It is certainly not new to integrate an entry port from the space beneigth a stage set.

In some special purpose uses of stage trap door/elevator apparatus, specialists in the arts have devised “pop up toaster” lift systems. These lift systems are particularly characterized in that they may be used to launch a performing artist or other cargo into the air like a toaster pops up slices of bread. Similar lift systems common in the art are generally based upon a hydraulic drive system.

While hydraulic drive systems are very good indeed for various reasons, they nevertheless have considerable drawbacks when used to motivate a lift used to launch a human load into the air. Chief among them is the lack of force profile control. Hydraulic fluid under pressure in a first chamber is allowed to pass into a second chamber having a lower pressure by a valve. It is very difficult to control with precision the pressure differential in a manner which precisely translates to a desired motion (acceleration) profile. For example, an initial force applied at the lift deck may be sudden and quite strong causing the performer to become startled and even lose balance.

Hydraulic based lift systems have further attributes which make use as pop-up elevators in stage set-ups less than ideal. Hydraulic pumps, reservoirs, and conduits tend to be bulky and consume considerable space so as to prevent practical use of such elevators in modular systems which demand that components be self-contained and not to appreciably infringe on neighboring or adjacent components. Further, hydraulic systems are often difficult to set-up, maintain and operate. They are additionally problematic with respect to being prone to leaks and related failures. Hydraulic drive systems deliver a very high power level needed to produce sufficient acceleration in pop-up elevators, however this power capacity is accompanied by a lack of control among other undesirable attributes. As such, there is a long felt need in stage provisioning arts to have alternative drive systems for pop-up type lift systems and elevators used with modular stage set-ups.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, Jose Cantu with inventions of stage lift systems. It is a primary objective of these lift systems to provide high performance special purpose lift functionality for use in conjunction with modular stages configured for performance arts.

In brief, a lifting system motivated by special purpose electric stepper motor or ‘servo’ provides lifting facility and function with respect to an understage space and an on-stage space. More specifically, a lift deck advances linearly from a first terminal position which lies under a main stage surface to a second terminal position which lies parallel, flush and coplanar with said main stage surface.

The lifting system or elevator is particularly arranged with specially arranged mechanical features and structure to specifically cooperate with objectives related to use as a modular stage component for performance arts and more specifically as a pop up elevator.

These apparatus include provision for variable height adjustability. Because stage systems which are temporary and modular are often set-up and fabricated to fit within spaces having variances, it is frequently the case that the precice height from a subfloor to a stage main surface varies from one installation to another. For this reason, these lift systems demand an adjustable height without causing appreciable performance degradation to the lift action.

In another important consideration, the lift deck is arranged to operate in several speed modes. In some operational modes, the lift deck rises between its two terminal positions with a very high acceleration which tends to lauch an unattached load upwardly into free flight. In alternative operational modes, the lift deck may advance between its terminal positions at a slow rate of speed to gently bring a load from under the stage to the stage main surface whereby the load never leaves contact with the lift deck.

Since these lift systems are part of modular kits which must cooperate with other stage components, they must not infringe upon the spaces and environments in which they are installed in a manner which would cause them to interfere with operation of those other stage components. Therefore, these systems are arranged with all moving parts in a discrete, contained well-defined space. Modular stage components may be abutted against and placed near these devices without interrupting nor infringing upon their operation and function regardless of the type and nature of the adjacent component.

In another important aspect of these devices, they are set up to cooperate with a remote controller. In performance stage operation strategies it is sometimes highly desireable to operate various components from a central control station. Since the lift system has various operational modes and its instantaneous states are preferrably to be synchronized with other related events, lift operations are beneficially controlled from a remote device or devices. As such, the electronic and mechanical systems which enable the lift system are integrated with special interfaces which permit remote control in connection with general purpose computing systems. In some preferred versions, these include control from common tablet computer platforms such as an iPad, Android or Surface devices.

### OBJECTIVES OF THE INVENTION

It is a primary object of the invention to provide special purpose equipment for use with high performance modular stage systems used in performance arts.

It is an object of the invention to provide lift systems which integrate with modular stage systems.

It is a further object to provide a self-contained, remotely controlled lift system with a very high lift rate.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a line drawing illustrative of a use case where a performer is launched by a lift system into the performance space above a main stage surface;

FIG. 2 is a perspective illustration of one version of lift system or elevators of these teachings;

FIG. 3 is another view of these lift systems;

FIG. 4 is a photograph image of a downward view showing a stepper motor coupled within one preferred version of a frameset and further to a belt drive via a pully system on fixed axes;

FIG. 5 is a photograph image of front-on perspective view of one preferred frameset showing a lift deck in postion at the top of its travel;

FIG. 6 is a photograph image showing a detail illustration of one preferred belt drive system; and

FIG. 7 is a photograph image of a stepper motor coupled to a belt drive system having two primary axels.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Modular Stage Component

A modular stage component is a system arranged to cooperate modularly with related components to form a stage system for performance arts especially a temporary stage system.

### Elevator

An elevator is a lifting system operable for receiving loads therein and conveying those loads in a prescribed manner to a final position or state of motion.

### Drive System

A drive system is a coupling between a movable mechanical system and a source of applied force.

### Lift Deck

A lift deck is a platform or plate arranged to receive loads thereon and to move between prescribed positions in a linear range of motion.

### Pop Up Toaster Lift

A pop up toaster lift is a lift system which tends to launch its load airborne in certain high acceleration modes of use.

### DETAILED DESCRIPTION AND PREFERRED EMBODIMENTS

In accordance with each of preferred embodiments of the invention, a lift system or elevator is provided as a modular stage system component. It will be appreciated that each of embodiments described include an apparatus and that the apparatus of one preferred embodiment may be different than the apparatus of any other embodiment. Accordingly, limitations read in one illustrative example should not be carried forward and implicitly assumed to be part of any other alternative example.

These lift systems are particularly characterized as ‘pop-up toaster lifts’ for integration with modular stages used in performing arts. More specifically as servo/belt driven lift systems or elevators having very high performance characteristics with particular regard to high acceleration and advanced acceleration control.

These lift systems are also distinguished by their particular arrangements of drive mechanics which facilitate height adjustments necessary in some advanced modular systems used as temporary stage set-ups.

Further to the objectives related to use of these special-purpose elevators as stage components, a special casters set and leveling means are integrated therewith.

Still further, as these devices are dynamically used during a stage performance, they are provided with control means which allows them to be set into motion and otherwise operated from remote locations such as a performance control station.

### Electric Motor

To address and solve many of the issues and problems known in devices of the arts, these lift systems abandon the cumbersome and difficult to manage hydraulic motivational force systems in favor of an all electric solution. Special-purpose electric motors fashioned as stepper motors or servo motors offer high power, high power density, very high positional control, durability, portability, among other favorable attributes which tend to make these lift systems superior to those attempted by others.

Stepper motors or servo motors permit precise positional control as pulse signals applied to poles of a motor's inductors cause the motor shaft to advance with very reliable precision in clear distinction to conventional motors were shaft position is not similarly controlled. Since the motor is controlled by series of pulses sent in time to alternative inductors, the shaft position control is readily manipulated—even where the timing is complex and highly varied over an extended period. Since the particular application at hand benefits considerably by such precise control, the servo motor may be considered far superior to alternative motivational sources such as hydraulics.

For example, when a lift deck is sitting stationary at an initial position and begins to accelerate, it is advantageous for this acceleration to be applied with some precise control. Abrupt application of high acceleration tends to startle a human load who may adversely respond by adjusting weight and standing position—a very bad thing prior to be launched into the air. To achieve a successful landing, a performer in a pop-up toaster lift must be well-positioned and ready for free flight. Losing one's balance during the launch process tends to bring about a very bad landings—a somewhat catastrophic event in performing arts.

Therefore, it is preferred if these lift systems do not startle human loads into imbalance as they are accelerated from a stationary position. A natural human response time (startle response) is well known for such actions as high upward acceleration, it is useful in these devices is the initial acceleration is quite modest for a very brief period then maximized thereafter. This permits a performer to maintain balance throughout the launch cycle. While competing systems might deploy an audible alert to warn users of an imminent acceleration—this requires a user to concentrate and predict the timing of initial acceleration. However, when stepper motors are used, a physical cue is delivered as very slight acceleration of the lift deck for 1/10 of a second prior to the full launch acceleration. This strategy tends to allow users to achieve a much better standing position for the launch process. However, it requires a complex acceleration profile and this can only be easily achieved with careful application (timing) of pulses to a stepper motor. In a stepper motor, timing of received pulses controls motor advance rather than intensity of received pulses. It is for this reason, in part, the stepper motors yield precisely the kind of control particularly desired in launching type lift systems taught herein.

Applying an acceleration profile in this fashion is not easy in hydraulic systems. Pressure control to effect a custom acceleration profile is not trivial. Conversely when using a stepper motor, electronic signals may be applied to achieve a complex and detailed acceleration profile optimized for launching a human subject in view of the natural human response to suddenly applied upward accelerations. For these reasons among others, use of an electric motor or more specifically an electric motor arranged as a stepper motor to provide motivational forces to special-purpose elevator operable for launching human loads airborne provide exceptional performance benefits.

Servo motors (or stepper motors) are additionally particularly suited for the tasks at hand. Since one primary objective is to launch performers into the air as they enter a performance-based (i.e. stage), the ultimate height of the flight path a performer achieves is of concern. For example, where a band is comprised of multiple performers and each is to enter the stage by a pop-up lift, it can become important to assure all performers reach similar height. In a scenario in which each of the performers have different weight, this can be a challenging tuning problem for systems of the art and especially those which are motivated by hydraulic sources. Systems of the art require increased force adjustments for heavy performers and decreased force for lighter performers to launch them to the same height. Setting a hydraulic system to deliver the correct force to the load is not easy.

However, servo motors don't operate in similar fashion. A servo motor shaft position is dependent upon the signals used to drive the motor. Shaft position translates directly to lift that position. No matter the weight of the load, the lift that position will be the same for a given set of drive signals sent to the servo motor. While the motor may consume more energy to lift heavy loads, a specific set of drive pulses delivered in time will cause a lift that to rise with the identical acceleration no matter what the load weight is. This is a considerable advantage. Where five band members all need to be similarly launched to a specific height, the operator only needs to arrange but a single set of drive pulses to the motors. If all of the performers randomly switch positions and thus less they would like to use, the system automatically accounts for the weight variance and all performers are launched identically with no further inputs, adjustments nor tuning from the control station.

Previous designers of similar mechanical systems have not attempted arrangements described herein as use of electric motors necessarily comes with some complexities which relate to coupling to the lift deck. Certainly hydraulic systems have a nice advantage in that regard as they include mechanical elements which naturally move linearly and easily couple with the motion of an elevator lift deck.

Stepper motors on the other hand generally have a shaft which rotates about an axis and necessitates complex translations of such rotational forces to achieve the necessary drive for a lift deck which must be translated linearly over a distance of about 2 meters. As such, apparatus taught herein includes a special-purpose arrangements of a belt drive coupling.

### Belt Drive

Belt drive couplings suggested herein including a particular example illustrated in detail in the figures and text have very good mechanical advantages which support objectives specifically related to use as a pop up toaster type lift system.

In one important example, a belt drive system may be arranged in a very thin or substantially planar (or cylindrical) space having a high aspect ratio. It is a primary goal of these systems to avoid apparatus and mechanics which extend beyond the space demarked by the frameset exterior boundaries. Since these components are intended to be used with modular stage systems, it is desirable that they sometimes be abutted with other systems whereby they don't interfere with those adjacent components.

Accordingly, it is greatly advantageous to contain an entire drive system within the bounds of the frameset of the device. Since the primary portion of the space is allocated for receiving the human load, the drive system must be fitted into small or thin rectangular spaces on either side of the lift deck. The belt drive system is particularly amenable to such configurations as a belt of sufficient strength may be conveniently made to be only 1 or 2 inches thick.

Another important advantage of using a belt drive system, relates to adjustability. Since a belt is a structure of arbitrary length, mechanical adjustments may be configured to drive these lift decks with an electric servo motor whereby the system height is readily adjustable in a continuous manner with no changes other than simple adjustments to the effective belt length. Idler pulleys and other terminal hardware may be adjusted in position whereby the operational length of the belt is extended or reduced to effect a variable system height. This is particularly useful because various stage setups demand different heights from a subfloor. Lift systems having fixed height require special spacing considerations to be installed at the subfloor upon which they are constructed.

Pop-up toaster lifts which have fixed height (as is quite common with hydraulic systems) are difficult to integrate when the stage surface is not at a predefined distance from the subfloor upon which a stage is set up. When the lift system supports a variable height adjustment, the device is easily integrated with various stage set-ups which have variable distances between the main stage surface and the subfloor. For this reason alone, a belt drive system offers considerable advantage.

In yet another benefit brought by belt drive systems, these arrangements can offer a natural shock absorber function. Belts made from durable rubber or other elastic materials tend to have a stretch behavior when under high tension loads.

This particularly suits the instant application as human loads returning from free flight land on the lift deck with considerable impact force. The belt drive permits an absorption of the impact giving the performer a softer landing and preferred safer return to the main stage surface.

Some of the preferred belt drive systems are further comprised of various gears and pulleys which are arranged to couple the a servo motor to the lift deck such that the motion of the linear travel path of a lift may be driven by a rotating shaft. Of course the precise placement, sizes, arrangements of pulleys and drive gears is highly variable and largely dependent upon good engineering choices rather than inventive design. Thus it serves little purpose to present significant further detail regarding these elements of the belt drive system. Competent engineers will easily appreciate various couplings between servo motors and these lift decks—in view of the requirement that the drive system occupies thin planar like spaces on either side of the frameset.

### Frameset

The main mechanical structure and skeleton from which these apparatus are built is herein referred to as the ‘frameset’. Welded aluminum extrusions for example may be arranged to form a rectangular cylindrical space and confines in which substantially all parts of these lift systems are fitted. The frameset demarks the volume of space (similar in size and shape to a phone booth) in which lies the drive system and the load receiving space. The frameset provides mechanical rigidity to all related elements and further supports mechanical coupling with cooperating components such as a stage main surface and the subfloor upon which it may be assembled.

A frameset provides a mounting and/or seat into which the servo motor may be placed and affixed. Pullys and/or gears may be rotatably fastened to various locations on the frameset to effect turning axes for routings of a drive belt. A frameset further defines a travel path of a lift deck which has an initial terminal position (at the bottom for example) and a final terminal position (flush with a stage surface) and between these the lift deck is linearly translated under urgence of force conveyed by the belt drive system.

A primary feature of preferred framesets includes a height adjustment means. A first portion of a frameset may be mechanically decoupled from a second portion and these may be displaced with respect to each other for example in a telescopic relationship to a new orientation and thereafter recoupled and reaffixed. This may be done in connection with an adjustment to the effective length of the belt system. In this way, the overall height of the lift system is made continuously variable. In modular stage systems, it is often the case that components need to be size adjusted to fit and cooperate with similar and related components.

As such, these framesets are engineered to include an important height adjustment feature which renders them more cooperative in view of multiple configuration setups.

### Floor Hardware

Framesets of these systems additionally support integration with certain floor hardware. While some versions may be rested upon a fixed base, other versions include a set of rolling casters attached to the base whereby the system may be easily rolled about flat floors or subfloors to be repositioned in relation to other stage components. As modular staging systems typically include many heavy components which must be frequently assembled and disassembled, and further moved from various locations, these lift systems benefit with regard to mobility when they include a heavy-duty casters set affixed at the bottom of the frameset. These pop-up toaster elevators used in permanent installations do not similarly benefit from such feature as integrated casters set.

Additionally, good placement and coupling with a stage main surface sometimes demands a leveling means by which the angular alignment may be fine adjusted. This is particularly important in view of the task at hand because as a lift deck becomes part of a stage main surface it is quite important to establish it as a parallel and flush integration therewith. To this end, a set of threaded elements having a foot portion suitable for setting on a cement floor are fashion in the corners of the frameset to operate as leveling means. By turning the threaded element in relation to a stationary frameset, a corner may be lifted or lowered to achieve desired alignments.

### Lift Deck

Finally, a lift deck element may be provided as a rectangular rigid plate or substrate of size sufficient to receive there on a human load. The lift deck may fasten and unfasten to the belt drive system including at clamps specifically provided to couple the lift deck to the belt drive system. So coupled, the lift deck operates to translate between two and point locations or terminal positions.

### Clamps

A special device is arranged to fasten to the belt and couple it to the lift deck. A clamp system which travels in a track provided by the frameset is affixed to the belt in a manner whereby the clamp moves with the belt and causes translation within the guide or track in which it is coupled. The clamp further fastens to the lift deck via mechanical fastener. In this way, the lift deck may be fastened to several portions of a belt system simultaneously. Indeed, is best versions, clamps at four belt locations provides a very smooth operation whereby the lift deck is lifted evenly and smoothly as the clamp travels in its travel path as defined by the frameset structures.

### Remote Control

Because many stage performances are presented as complex organization of events which sometimes are highly coordinated in time, it is often the case that a central control station is used to manage event timing. For this reason, high performance versions of these systems include a special electronic controller apparatus which is coupled to deliver drive signals to the stepper motor. This electronic controller is further arranged to receive drive commands from a remote station by radio. While power is provided locally, execution commands are received remotely whereby the states of the lift system may be managed by persons far from it.

In best versions, remote control may be arranged about a common WiFi network in which a tablet computer such as an iPad running a custom application thereon its iOS operating system sends command signals which can be interpreted by the controller also similarly in communication via WiFi. In this way, a show director can activate the elevator with perfect timing without having to be physically near the lift apparatus. Of course, safety lockouts prevent inadvertent activation when loading the lift. But once loads are properly in place and assured by local operators for example, then the application can permit activation from afar by the simple press of a command button. As such, preferred versions of these systems are remotely driven by radio control.

### DESCRIPTIONS OF THE FIGURES

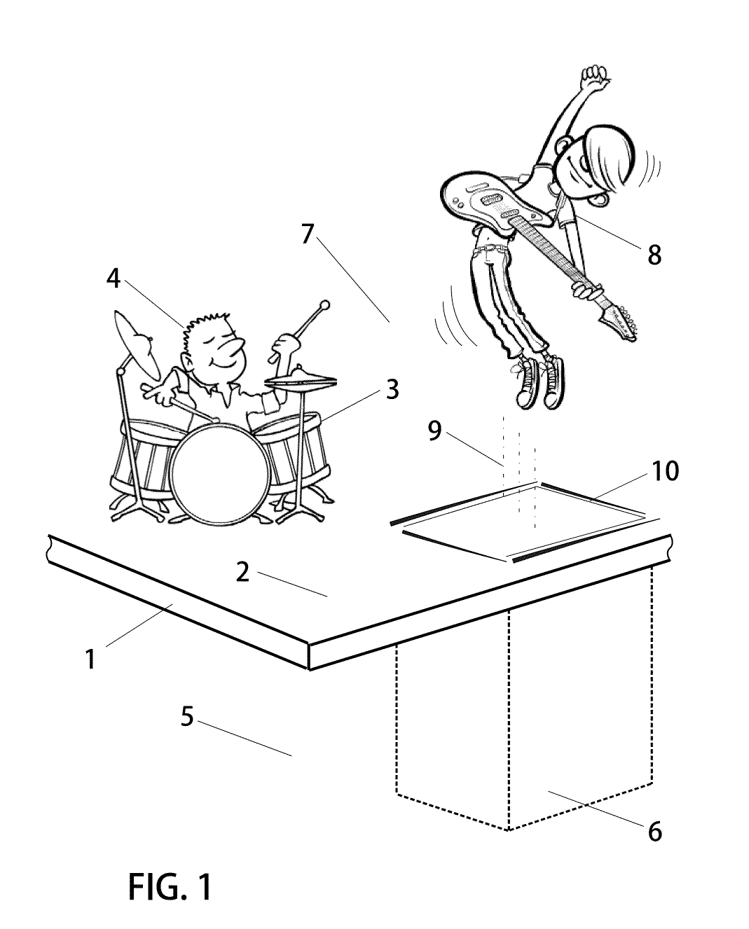

A first illustrative example presented to convey an overall impression of the system is offered as FIG. 1 in which a stage performer such as a musician enters a stage performance area via a space beneigth the stage. Specifically, the stage 1 main surface 2 onto which various items of performance equipment may be placed such as a drumset 3. Additionally, performers 4 may be accommodated on such stages at its top surface.

A space 5 beneigth the stage may contain therein supporting equipment and apparatus used to bring about effect related to performance of the show. One particular example is a special purpose lifting apparatus 6 which may be specifically arranged to convey performers from a hidden space beneigth the stage onto the performance space 7 above the stage surface—in spectacular fashion. Specifically, a rockstar 8 may be launched upwardly 8 from a lift deck 9 through a special purpose hole 10 provided in conjuction with the lift system. The pop-up lift system is specially purposed with a high acceleration such that loads placed therein are launched into the air as the lift deck goes from a first initial position to a final position where the lift deck is flush with the main stage surface.

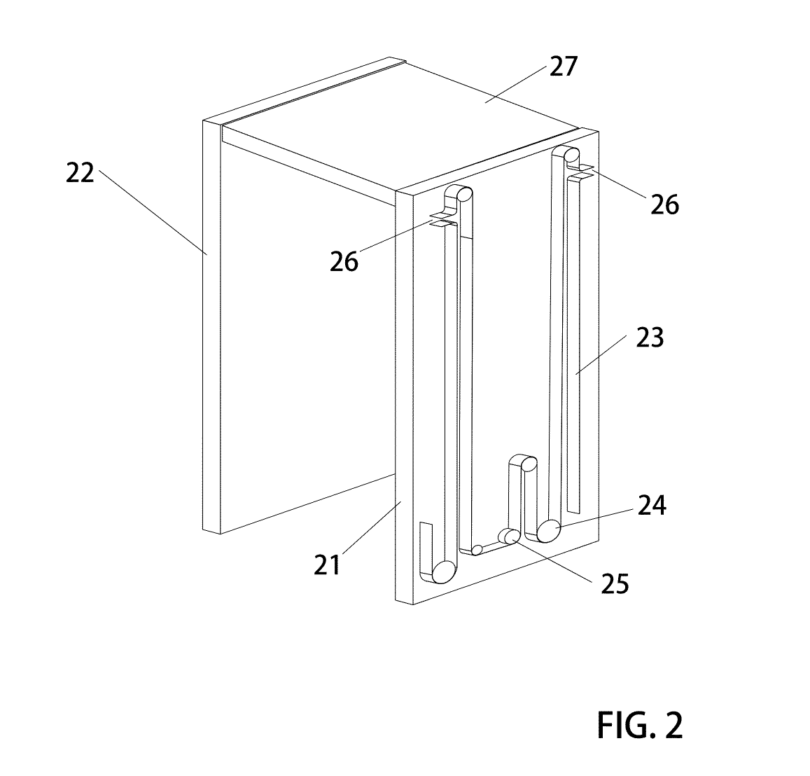

FIG. 2 is a perspective drawing to illustrate the important nature of the drive system and its spatial relationship within the apparatus. Since the primary core of the device is reserved for travel of the lift deck and human loads therein, it is necessary to arrange the drive system as a belt confined to a thin space on either side of the lift. A planar or cylindrical thin rectangular cross section space 21 and space 22 on the opposing side is occupied by belt systems 23 including drive gears 24 and pullys 25. The belt may be affixed at a terminal end 26 to a clamp hardware which further couples with the lift deck 27.

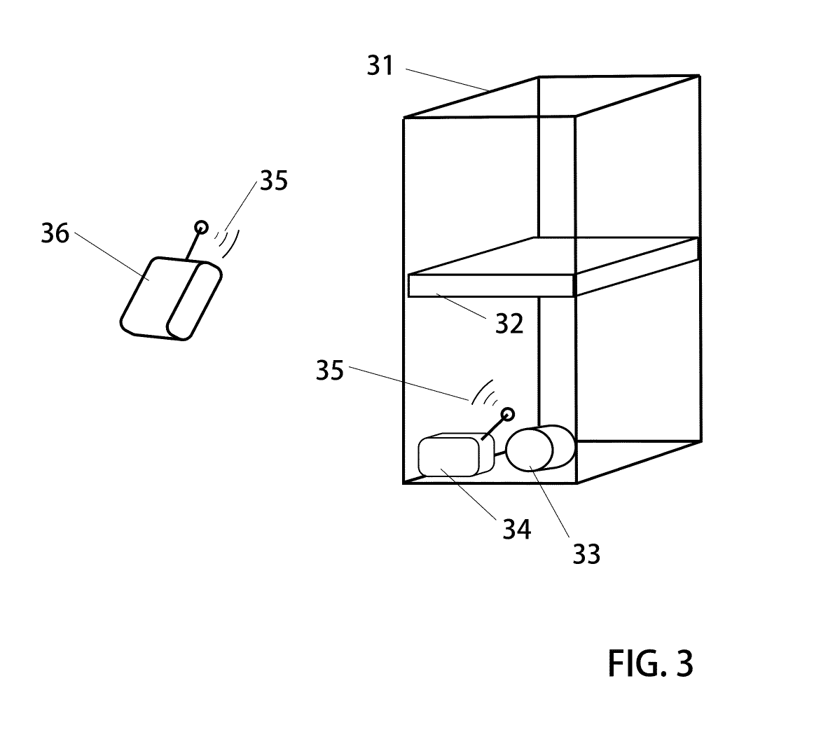

FIG. 3 illustrates a lift system having a frameset 31 which demarks the space in which a lift deck 32 travels from a position at the bottom of the lift to a terminal position at the top. An electric motor 33 receives power electronic pulses supplied by a controller 34 which is connected to an electrical power supply. The controller further receives control signals by radio wave 35, for example via WiFi. A remote control system 36 preferrably a standard tablet computer arranged to run application specific software causes the lift system to be activated and controlled from anywhere within the WiFi range. Operational modes and operational states may be changed by a show director as a performance is played.

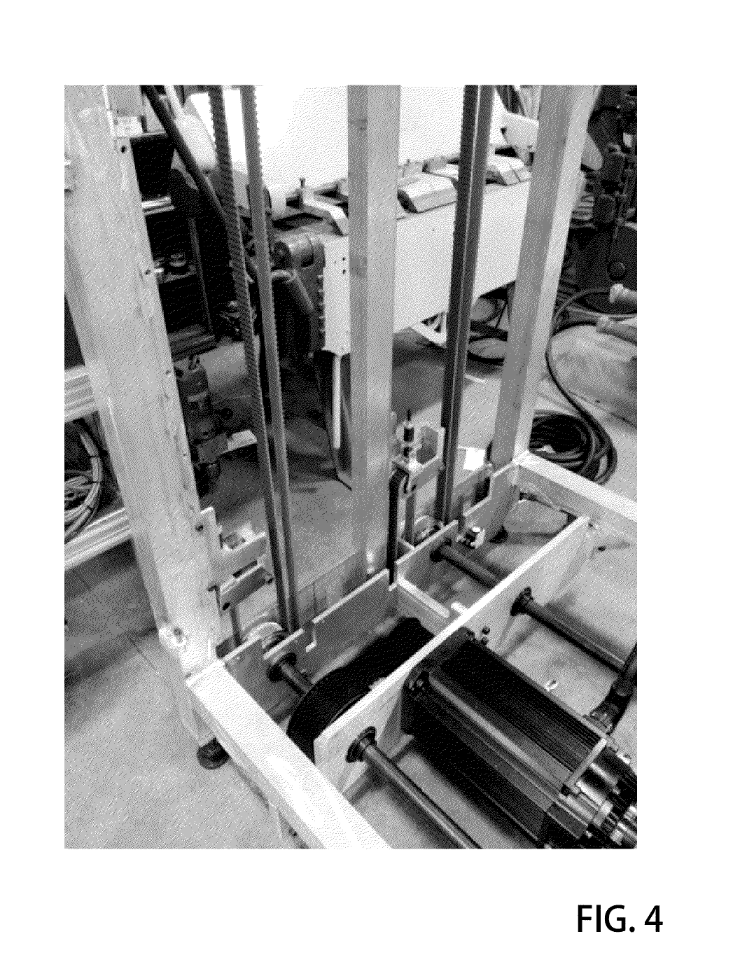

FIG. 4 is a photograph of one preferred version which shows in detail a frameset of welded aluminum into which a stepper motor is firmly mounted and affixed between two axels or shafts which are coupled to each other and driven via gears mounted thereon. Rotational forces applied to these shafts from the motor are converted to linear motions along the direction of travel of the belts.

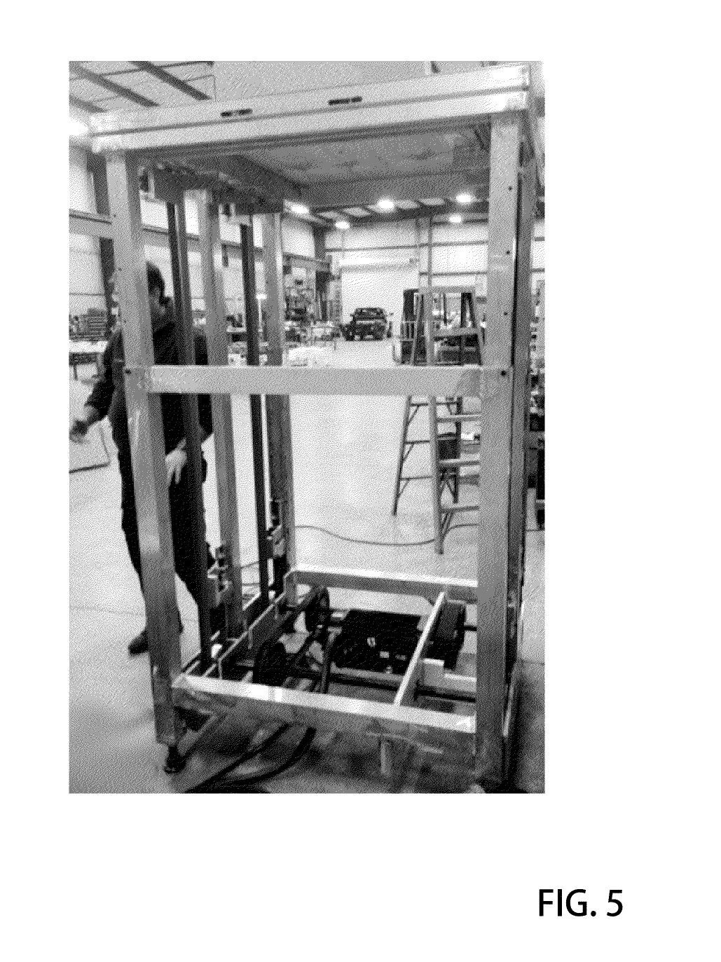

FIG. 5 shows a front-on detailed view of a frameset with a lift deck at the top of the travel. Further, leveling legs may be viewed in the corner of the frameset to provide for excellent alignment of these systems when set up on sturdy floors such as a cement subfloor.

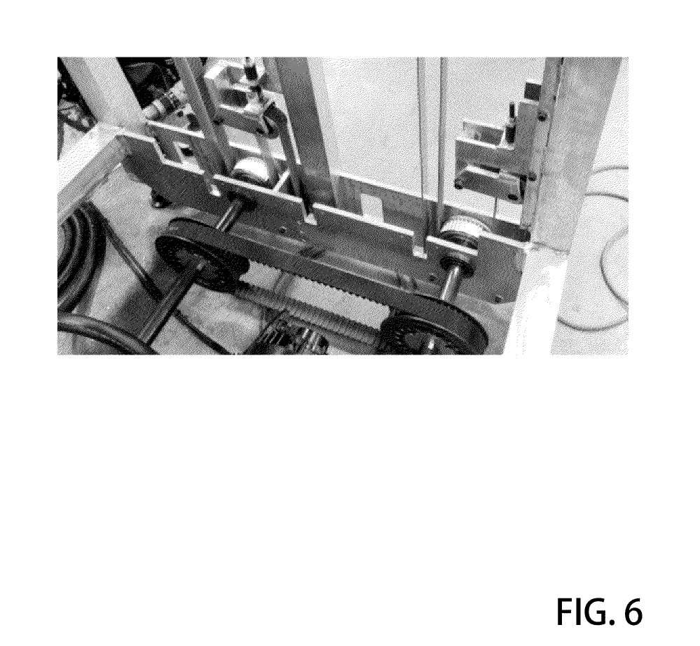

FIG. 6 illustrates a coupling between two rotating shafts to provide for drive energy to be conveyed to the distributed belt system for even pressure on the lift deck in multiple locations to which it is affixed.

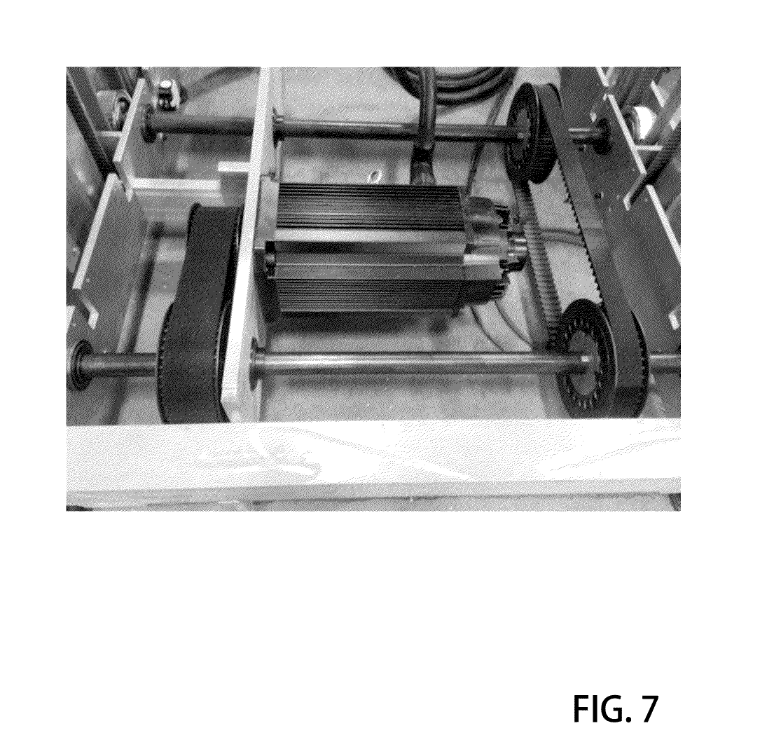

FIG. 7 shows a single electric motor and its relationship with the two drive shafts via gears which assure each is turned at precisely the same rate causing even lifting pressure to be applied at multiple points on the lift deck further assuring a smooth advance from an initial terminal position to a final terminal position.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how high performance, special-purpose elevators may be fashioned as modular performance stage components. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) A modular stage component arranged as an elevator comprising:
a lift deck;
an electric motor;
a drive system; and
a rigid frameset;
said rigid frameset forms the boundary of a containment space in which lies said lift deck, electric motor, and drive system,
said electric motor is mechanically coupled to said lift deck by way of said drive system whereby the lift deck is motivated to advance linearly from an initial terminal position to a final terminal position.

2) A modular stage component elevator of claim 1, further characterized as a high acceleration lift system having an acceleration rate greater than that of gravity whereby a load being lifted separates from the lift deck and is launched into free flight as the lift deck reaches its final terminal position.

3) A modular stage component elevator of claim 1, further characterized as a remotely controlled lift system having a plurality of operational modes and operational states whereby those modes and states may be manipulated from an application running on a general purpose computing platform such as a tablet computer having a conventional operation system.

4) A modular stage component elevator of claim 2, further characterized as having sufficient lift capacity whereby a human performer may be launched from the lift deck into a space above a stage surface.

5) A modular stage component elevator of claim 4, further characterized as having sufficient lift capacity whereby a human performer is appreciably launched against the force of gravity as to rise in free flight above a stage main surface to a height greater than one meter.

6) A modular stage component elevator of claim 4, said containment space formed by said rigid frameset is of sufficient volume to accommodate therein a human stage performer.

7) A modular stage component elevator of claim 1, further comprising a controller interface arranged to receive radio signal commands and respond to so received commands by applying electronic drive signals to said electric motor.

8) A modular stage component elevator of claim 7, said electric motor is further characterized as a stepper motor of servo motor.

9) A modular stage component elevator of claim 1, said drive system is further characterized as a belt drive system integrated within two opposing sides of said frameset system driven by said electric motor.

10) A modular stage component elevator of claim 9, each of said opposing sides is characterized as a high aspect ratio substantially planar space whereby the amount of space consumed by the belt drive is appreciably less than the amount of space available to receive loads to be lifted.

11) A modular stage component elevator of claim 1, further comprising:
a castors set; and
a leveling system,
the casters and leveling devices are affixed at the base of the frameset to effect spatial alignment adjustability and rolling functionality.

12) A modular stage component elevator of claim 1, said rigid frameset is adjustable in height, such that one frame portion may be mechanically decoupled from another and moved linerally upward to be recoupled and reaffixed to effect a height adjustment whereby the drive system can accommodate the new height.
